(19) United States
(12) Patent Application Publication
(10) Pub. No.: US 2011/0178987 A1
(43) Pub. Date: Jul. 21, 2011

(54) APPARATUS AND METHOD FOR PROCESSING DATA ACCORDING TO REMOTE CONTROL IN DATA STORAGE DEVICE

(75) Inventor: Jin Hyeock Choi, Suwon-si (KR)

(73) Assignee: SAMSUNG ELECTRONICS CO., LTD., Suwon-si (KR)

(21) Appl. No.: 12/964,242

(22) Filed: Dec. 9, 2010

(30) Foreign Application Priority Data
Jan. 15, 2010 (KR) 10-2010-0003863

(51) Int. Cl. G06F 17/00; G06F 21/00; G06F 11/00

(52) U.S. Cl. 707/646; 726/2; 714/48; 707/E17.007; 714/E11.149; 714/E11.188

(57) ABSTRACT

A method and apparatus for processing data at a data storage device according to remote control are provided. In response to a remote control permission request being received from a remote control device, identification information included in the remote control permission request may be authenticated. A remote control command according to a right corresponding to the identification information may be performed when the remote control command is received from the remote control device.

### CROSS-REFERENCE TO RELATED APPLICATION(S)

This application claims the benefit under 35 U.S.C. §119(a) of Korean Patent Application No. 10-2010-0003863, filed on Jan. 15, 2010, in the Korean Intellectual Property Office, the entire disclosure of which is incorporated herein by reference for all purposes.

### BACKGROUND

1. Field

The following description relates to an apparatus and method of remotely processing data, and more particularly, to a method of storing, transmitting, sharing, and backing up mass data such as multimedia data using a data storage device.

2. Description of Related Art

With developments in performance of processors, networks, and input/output devices in digital terminals, services providing a motion picture, including mass data such as high definition (HD) motion picture and multimedia data such as MPEG audio layer-3 (MP3), are currently generalized.

Amounts of content, generated by an individual user, and multimedia files, such as audio and video, have increased, and thus amounts of digital data managed by the individual user have increased. Accordingly, due to a limitation on storing data in hard disk of an existing personal computer, external hard disks based on a tera unit have been utilized.

The above digital data may be shared by other users using the Internet, blogs, and the like. However, since the digital data is mass data, and is large in size, it is difficult to easily share the mass digital data.

### SUMMARY

In one general aspect, there is provided a method of processing data at a data storage device according to a remote control, the method including: authenticating identification information included in a remote control permission request, in response to the remote control permission request being received from a remote control device, and performing a remote control command according to a right corresponding to the identification information, in response to the remote control command being received from the remote control device.

The method may further include that the performing the remote control command includes: verifying file information including an access right according to the right, and transmitting the verified file information to the remote control device, in response to the remote control command corresponding to a file information request command.

The method may further include that the performing the remote control command includes transmitting a selected file to the remote control device or another data storage device, according to the right, in response to the remote control command corresponding to a selected file transmission command.

The method may further include that the performing the remote control command further includes transmitting, to the remote control device, an error message indicating a corresponding user has no transmission right, in response to a user's not holding a transmission right.

The method may further include that the performing the remote control command includes receiving and storing a file from the remote control device or another data storage device according to the right, in response to the remote control command corresponding to a file storage command.

The method may further include that the performing the remote control command further includes transmitting, to the remote control device, an error message indicating a corresponding user has no storage right, in response to a user's not holding a transmission right.

The method may further include transmitting, to the remote control device, an error message indicating the remote control permission request is a failure, in response to the identification information being unauthenticated.

The method may further include transmitting, to the remote control device, a remote control permission response indicating the remote control permission request is a success, in response to the identification information being authenticated.

The method may further include backing up data of another data storage device in a to backup space corresponding to a predetermined storage space of a corresponding data storage device at predetermined time intervals.

The method may further include backing up data of another data storage device in a backup space corresponding to a predetermined storage space of a corresponding data storage device at predetermined time intervals.

The method may further include updating and storing predetermined data or the entire data in a backup space corresponding to a predetermined storage space of another data storage device.

In another general aspect, there is provided a data storage device for processing data according to a remote control, including: an authenticator configured to authenticate identification information included in a remote control permission request, in response to the remote control permission request being received from a remote control device, and a remote control processor configured to perform a remote control command according to a right corresponding to the identification information, in response to the remote control command being received from the remote control device.

The method may further include that, in response to the remote control command corresponding to a file information request command, the remote control processor is further configured to: verify file information including an access right according to the right, and transmit the verified file information to the remote control device.

The method may further include that, in response to the remote control command corresponding to a selected file transmission command, the remote control processor is further configured to transmit a selected file to the remote control device or another data storage device, according to the right.

The method may further include that, in response to a user's not holding a transmission right, the remote control processor is further configured to transmit, to the remote control device, an error message indicating the user has no transmission right.

The method may further include that, in response to the remote control command corresponding to a file storage command, the remote control processor is further configured to receive and store a file from the remote control device or another data storage device, according to the right.

The method may further include that, in response to a user's not holding a storage right, the remote control processor is further configured to transmit, to the remote control device, an error message indicating the user has no storage right.

The method may further include that, in response to the identification information being unauthenticated, the authenticator is further configured to transmit, to the remote control device, an error message indicating the remote control permission request is a failure.

The method may further include that, in response to the identification information being authenticated, the authenticator is further configured to transmit, to the remote control device, a remote control permission response indicating the remote control permission request is a success.

The method may further include a backup processor configured to back up data of another data storage device in a backup space corresponding to a predetermined storage space of a corresponding data storage device at predetermined time intervals.

The method may further include a backup processor configured to update and store predetermined data or the entire data in a backup space corresponding to a predetermined storage space of another data storage device at predetermined time intervals.

Other features and aspects may be apparent from the following detailed description, the drawings, and the claims.

### BRIEF DESCRIPTION OF THE DRAWINGS

FIG. 1 is a diagram illustrating an example of a configuration of a remote control system.

FIG. 2 is a diagram illustrating an example of a configuration of a data storage device remotely controlled.

FIG. 3 is a flowchart illustrating an example of a method of remotely controlling a data storage device.

FIG. 4 is a flowchart illustrating an example of a method of performing a remote control command at a data storage device.

FIG. 5 is a diagram illustrating an example of a process of transmitting data from a data storage device to another data storage device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

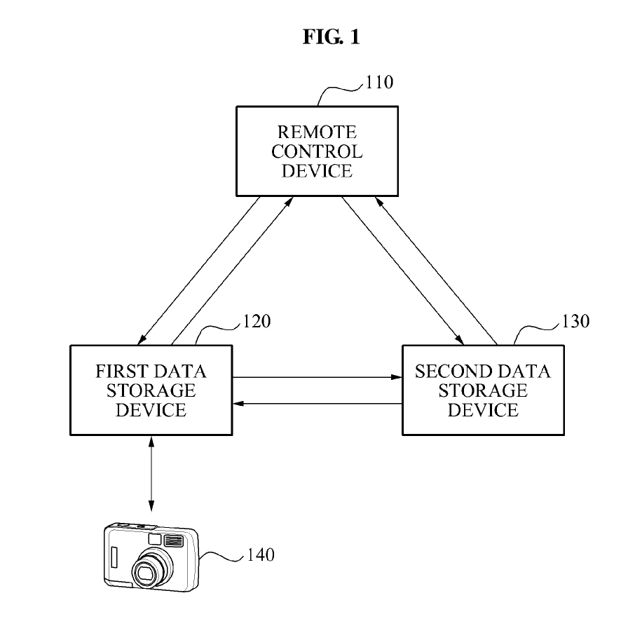

FIG. 1 illustrates an example of a configuration of a remote control system. In this example, the remote control system includes a remote control device 110 and at least one data storage device, for example, a first data storage device 120 and a second data storage device 130.

The first data storage device 120 and the second data storage device 130 are connected to the Internet over a network, and function to store, share, and back up data according to a remote control command of the remote control device 110. The first data storage device 120 and the second data storage device 130 may be connected to and operate on a 24-hour network.

When the first data storage device 120 is connected to a digital device, for example, a digital camera 140, via a universal serial bus (USB), the first data storage device 120 may recognize the connected digital camera 140 as an external storage device, and may control the digital camera to function as an auxiliary storage device of the first data storage device 120.

The remote control device 110 may transmit a remote control permission request to the first data storage device 120 and the second data storage device 130. When a corresponding user of the remote control device is an authorized user, the remote control device 110 may remotely control the first data storage device 120 and the second data storage device 130.

The remote control device 110 may output data, stored in the first data storage device 120 and the second data storage device 130, to be in the same format as a window searcher. The remote control device 110 may perform remote control functions of storing, transmitting, sharing, backing up, and the like, using a same manipulation scheme as the window searcher to manage data in the first data storage device 120 and the second data storage device 130.

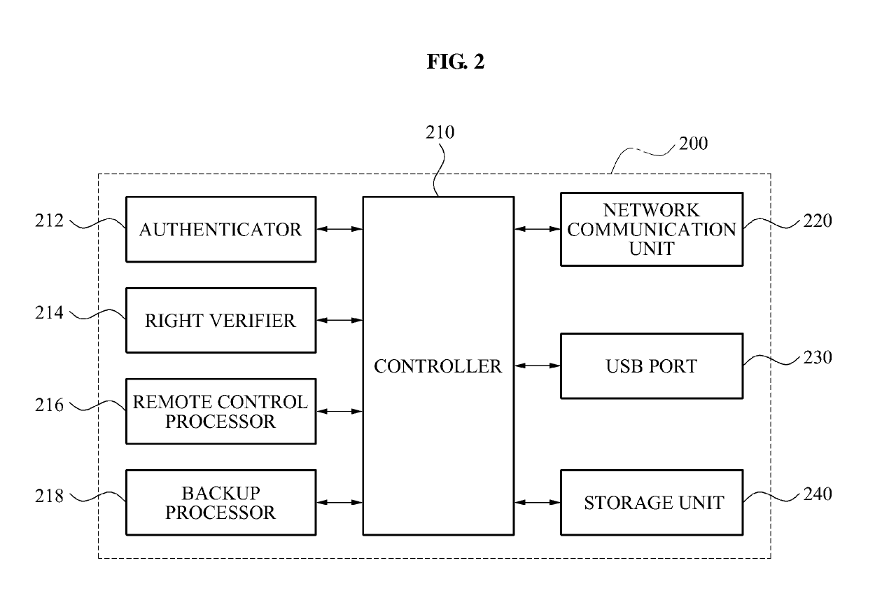

Examples of a configuration and operation method of a data storage device are further described with reference to the examples in FIGS. 2 through 5.

FIG. 2 illustrates an example of a configuration of a data storage device 200 that is remotely controlled. The data storage device in this example includes a controller 210, an authenticator 212, a right verifier 214, a remote control processor 216, a backup processor 218, a network communication unit 220, a USB port 230, and a storage unit 240.

The network communication unit 220 may connect a remote control device (e.g., the remote control device 110 in FIG. 1) and another data storage device (e.g., one of the first data storage device 120 and the second data storage device 130 in FIG. 1) via, for example, an 802.11 wireless local area network (WLAN), Ethernet, or another communication standard. However, the connection is not limited to these examples.

The USB port 230 may detect a directly connected external storage device.

The storage unit 240 may store mass data according to a control of the remote control device. For example, a hard disk or a solid state disk (SSD) may be employed as the storage unit 240. The storage unit is not limited to these examples however.

In response to a remote control permission request being received from the remote control device, the authenticator 212 may verify whether a corresponding user is an authorized user based on identification information included in the remote control permission request. In response to the user being the authorized user, the authenticator 212 may transmit, to the remote control device, a remote control permission response indicating the remote control permission request is a success. Conversely, in response to the user not being the authorized user, the authenticator 212 may transmit, to the remote control device, an error message indicating the remote control permission request is a failure. The identification information may include an email address.

The right verifier 214 may verify a registered user right corresponding to the identification information. Types of rights may include, for example, rights to read, write, access, update, delete, and the like.

In response to a remote control command being received from the remote control device, the remote control processor 216 may process the remote control command according to the verified right. Processing the remote control command according to the right may indicate processing the remote control command within the right. For example, when the remote control command may not be processed using the verified right, the remote control processor 216 may inform that the user has no right, and may not perform the remote control command.

In response to the remote control command corresponding to a file information request command, the remote control processor 216 may verify file information having an access right accessible by the user of the identification information, and may transmit the verified file information to the remote control device.

In response to the remote control command corresponding to a file storage command, the remote control processor 216 may verify whether the user holds a storage right. In response to the user's holding the storage right, for example, a right to write, the remote control processor 216 may receive and store a file from the remote control device or the other data storage device.

In response to the remote control command corresponding to a selected file transmission command, the remote control processor 216 may verify whether the user holds a transmission right with respect to a selected file, for example, a right to read the selected file. In response to the user's holding the transmission right, the remote control processor 216 may transmit the selected file to the remote control device or the other data storage device designated by the user.

Conversely, in response to the user's not holding a right suitable for a corresponding command, the remote control processor 216 may transmit, to the remote control device, an error message indicating the user has no right.

The backup processor 218 may provide a partial space of the storage unit 240 to the other data storage device as a backup space. The backup processor 218 may control a portion of or all of the data stored in the storage unit 240 to be updated and be stored in the to backup space of the other data storage device at predetermined time intervals.

The controller 210 may control a general operation of the data storage device 200, and also control the authenticator 212, the right verifier 214, the remote control processor 216, and the backup processor 218. The controller 210 may perform functions of the authenticator 212, the right verifier 214, the remote control processor 216, and the backup processor 218. The authenticator 212, the right verifier 214, the remote control processor 216, and the backup processor 218 are separately provided here for ease of description. Accordingly, a portion or all of the authenticator 212, the right verifier 214, the remote control processor 216, and the backup processor 218 may be configured to be processed by the controller 210.

An example of a method of processing data according to a remote control at a data storage device constructed as above is described.

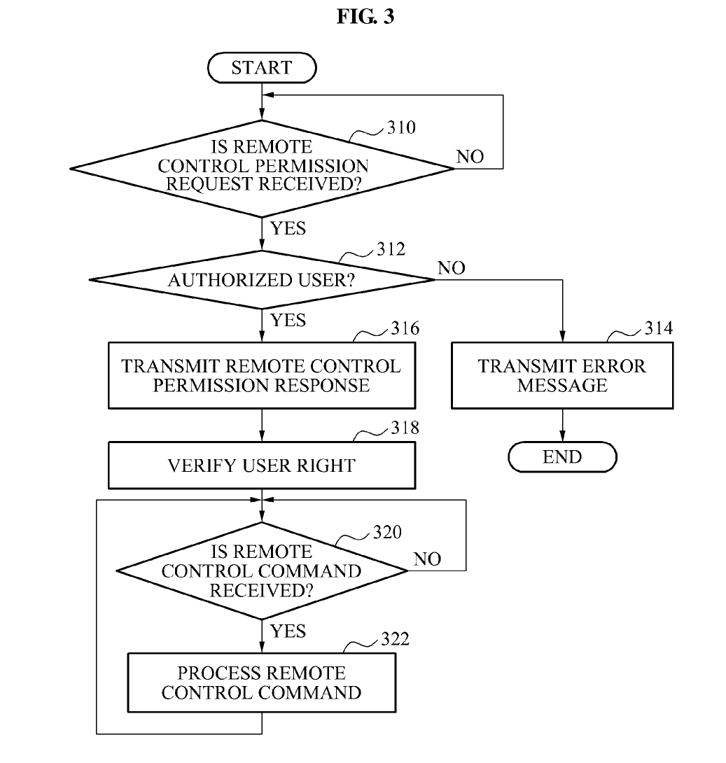

FIG. 3 illustrates an example of a method of remotely controlling a data storage device. When a remote control permission request is received from a remote control device in operation 310, the data storage device may verify whether a user is an authorized user based on identification information included in the remote control permission request in operation 312.

In response to the user's not being the authorized user, the data storage device (e.g., data storage device 200 in FIG. 2) may transmit, to the remote control device, an error message indicating the remote control permission request is a failure in operation 314.

Conversely, in response to the user's being the authorized user, the data storage device may transmit, to the remote control device, a remote control permission response indicating the remote control permission request is a success in operation 316.

In operation 318, the data storage device may verify a right corresponding to identification information included in the remote control permission request to verify a right of the user.

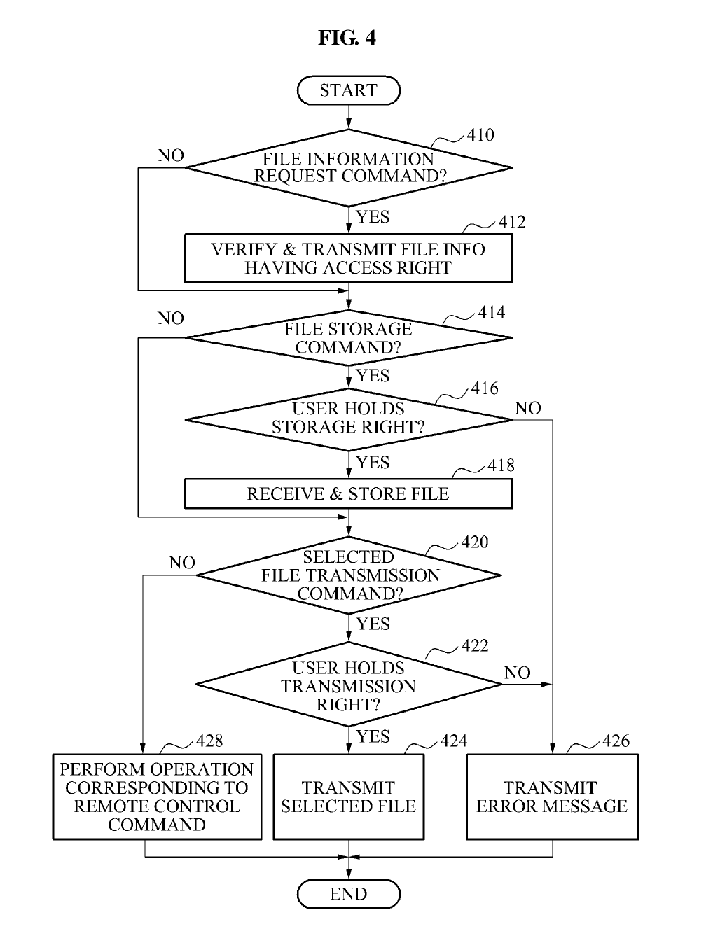

In response to a remote control command being received from the remote control device in operation 320, the data storage device may process the remote control command in operation 322 and may return to operation 320. An example of a process for processing the remote control command is described below with reference to FIG. 4.

FIG. 4 illustrates an example of a method of performing a remote control command at a data storage device.

In response to a received remote control command corresponding to a file information request command in operation 410, the data storage device (e.g., data storage device 200 in FIG. 2) may verify file information having an access right accessible by a user of identification information, and may transmit the verified file information to a remote control device in operation 412.

In response to the remote control command corresponding to a file storage command in operation 414, the data storage device may verify whether the user holds a storage right in operation 416.

In response to the user holds the storage right in operation 416, the data storage device may receive and store a file from the remote control device or another data storage device in operation 418.

In response to the remote control command corresponds to a selected file transmission command in operation 420, the data storage device verifies whether the user holds a transmission right with respect to a selected file in operation 422.

In response to the user's holding the transmission right in operation 422, the data storage device may transmit the selected file to the remote control device or the other data storage device in operation 424.

In response to the user's not holding the storage right in operation 416, or in response to the user's not holding the transmission right in operation 422, the data storage device may transmit, to the remote control device, an error message indicating the user has no right in operation 426.

In response to the remote control command not corresponding to the selected file transmission command in operation 420, the data storage device may perform an operation corresponding to the remote control command according to the right in operation 428.

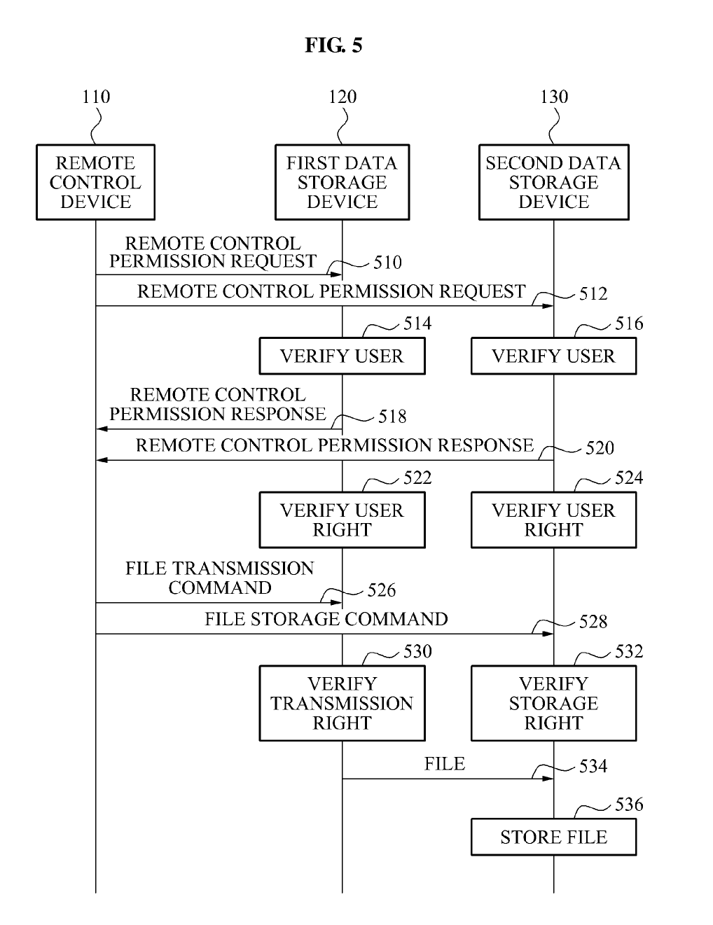

FIG. 5 illustrates an example of a process of transmitting data from a data storage device to another data storage device.

At operations 510 and 512, a remote control device 110 may transmit a remote control permission request to a first data storage device 120 and a second data storage device 130.

At operations 514 and 516, the first data storage device 120 and the second data storage device 130 may verify whether a user is an authorized user. In response to the user's being the authorized user, the first data storage device 120 and the second data storage device 130 may transmit, to the remote control device 110, a remote control permission response permitting remote control at operations 518 and 520.

At operations 522 and 524, the first data storage device 120 and the second data storage device 130 may verify a user right corresponding to identification information.

At operation 526, the remote control device 110 may transmit, to the first data storage device 120, a selected file transmission command that is the remote control command. At operation 528, the remote control device 110 may transmit, to the second data storage device 130, a file storage command that is the remote control command.

The first data storage device 120 receiving the file transmission command may verify whether the user holds a transmission right with respect to the selected file at operation 530. In response to the user's holding the transmission right, the first data storage device 120 may transmit the selected file to the second data storage device 130 at operation 534.

The second data storage device 130 receiving the file storage command may verify whether the user holds a storage right at operation 528. In response to the user's holding the storage right, the second data storage device 130 may store the received file at operation 536.

In response to the remote control device 110 being terminated after transmitting the file transmission command and the file storage command at operations 526 and 528, the file transmission at 534 may continue.

According to some examples, it may be possible to store, transmit, and back up mass data, such as multimedia data, using a data storage device. When the data storage device is used for an individual user, the data storage device may be referred to as a “personal data device.”

As a non-exhaustive illustration only, the remote control device, data storage device or personal data device may be a terminal device, and may refer to mobile devices such as a cellular phone, a personal digital assistant (PDA), a digital camera, a portable game console, an MP3 player, a portable/personal multimedia player (PMP), a handheld e-book, a portable laptop and/or tablet PC, a global positioning system (GPS) navigation, and devices such as a desktop PC, a high definition television (HDTV), an optical disc player, a set top and/or setup box, and the like, capable of wireless communication or network communication consistent with that disclosed herein.

According to the examples above, there may be provided a method and apparatus for storing, transmitting, sharing, and backing up mass data such as multimedia data using a data storage device. When a remote control device is terminated after transmitting a data transmission command to data storage devices, a data transmission between the data storage devices may be repeatedly performed. Accordingly, it may be possible to provide a user convenience of controlling a data storage device via a remote control device. Since data between the data storage devices is backed up at predetermined time intervals, it may be possible to reduce a data loss.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing data at a data storage device according to a remote control, the method comprising:
authenticating identification information included in a remote control permission request, in response to the remote control permission request being received from a remote control device; and
performing a remote control command according to a right corresponding to the identification information, in response to the remote control command being received from the remote control device.

2. The method of claim 1, wherein the performing the remote control command comprises:
verifying file information comprising an access right according to the right; and
transmitting the verified file information to the remote control device, in response to the remote control command corresponding to a file information request command.

3. The method of claim 1, wherein the performing the remote control command comprises transmitting a selected file to the remote control device or another data storage device, according to the right, in response to the remote control command corresponding to a selected file transmission command.

4. The method of claim 3, wherein the performing the remote control command further comprises transmitting, to the remote control device, an error message indicating a corresponding user has no transmission right, in response to a user's not holding a transmission right.

5. The method of claim 1, wherein the performing the remote control command comprises receiving and storing a file from the remote control device or another data storage device according to the right, in response to the remote control command corresponding to a file storage command.

6. The method of claim 5, wherein the performing the remote control command further comprises transmitting, to the remote control device, an error message indicating a corresponding user has no storage right, in response to a user's not holding a transmission right.

7. The method of claim 1, further comprising transmitting, to the remote control device, an error message indicating the remote control permission request is a failure, in response to the identification information being unauthenticated.

8. The method of claim 1, further comprising transmitting, to the remote control device, a remote control permission response indicating the remote control permission request is a success, in response to the identification information being authenticated.

9. The method of claim 1, further comprising backing up data of another data storage device in a backup space corresponding to a predetermined storage space of a corresponding data storage device at predetermined time intervals.

10. The method of claim 1, further comprising updating and storing predetermined data or the entire data in a backup space corresponding to a predetermined storage space of another data storage device.

11. A data storage device for processing data according to a remote control, the data storage device comprising:
an authenticator configured to authenticate identification information included in a remote control permission request, in response to the remote control permission request being received from a remote control device; and
a remote control processor configured to perform a remote control command according to a right corresponding to the identification information, in response to the remote control command being received from the remote control device.

12. The data storage device of claim 11, wherein, in response to the remote control command corresponding to a file information request command, the remote control processor is further configured to:
verify file information comprising an access right according to the right; and
transmit the verified file information to the remote control device.

13. The data storage device of claim 11, wherein, in response to the remote control command corresponding to a selected file transmission command, the remote control processor is further configured to transmit a selected file to the remote control device or another data storage device, according to the right.

14. The data storage device of claim 13, wherein, in response to a user's not holding a transmission right, the remote control processor is further configured to transmit, to the remote control device, an error message indicating the user has no transmission right.

15. The data storage device of claim 11, wherein, in response to the remote control command corresponding to a file storage command, the remote control processor is further configured to receive and store a file from the remote control device or another data storage device, according to the right.

16. The data storage device of claim 15, wherein, in response to a user's not holding a storage right, the remote control processor is further configured to transmit, to the remote control device, an error message indicating the user has no storage right.

17. The data storage device of claim 11, wherein, in response to the identification information being unauthenticated, the authenticator is further configured to transmit, to the remote control device, an error message indicating the remote control permission request is a failure.

18. The data storage device of claim 11, wherein, in response to the identification information being authenticated, the authenticator is further configured to transmit, to the remote control device, a remote control permission response indicating the remote control permission request is a success.

19. The data storage device of claim 11, further comprising a backup processor configured to back up data of another data storage device in a backup space corresponding to a predetermined storage space of a corresponding data storage device at predetermined time intervals.

20. The data storage device of claim 11, further comprising a backup processor configured to update and store predetermined data or the entire data in a backup space corresponding to a predetermined storage space of another data storage device at predetermined time intervals.
